(19) United States
(12) Patent Application Publication
(10) Pub. No.: US 2016/0305645 A1
(43) Pub. Date: Oct. 20, 2016

(54) LIGHTED TRANSLUCENT HAT

(71) Applicant: Asia Hall, Encino, CA (US)

(72) Inventor: Asia Hall, Encino, CA (US)

(21) Appl. No.: 14/690,532

(22) Filed: Apr. 20, 2015

(51) Int. Cl. F21V 33/00; F21V 23/02; F21V 23/00; A42B 1/24

(52) U.S. Cl. CPC F21V 33/0008; A42B 1/244; F21V 23/023; F21V 23/003; F21Y 2103/006

(57) ABSTRACT

A hat is provided, comprising a brim, a crown, electroluminescent (EL) wire forming an outline at least around the brim and the crown, a battery pack secured to the underside of the crown, and a controller, secured to the underside of the crown and electrically coupled to the battery pack and the EL wire, configured to control the current applied to the EL wire. The brim and crown are formed from a translucent material. A method of manufacturing a hat is also provided, comprising: providing a translucent material, forming a brim and crown of the translucent material, securing an electroluminescent (EL) wire around at least the brim and crown, providing a battery pack, providing a controller, electrically coupling the EL wire to the battery pack and controller, and securing the battery pack and controller to the underside of the crown.

### RELATED APPLICATION DATA

The present application is related to commonly-assigned and co-pending U.S. Provisional Application Ser. No. 61/976,770, entitled A WEARABLE COWBOY HAT LINED WITH EL WIRE THAT LIGHTS UP, filed on Apr. 8, 2014, which application is incorporated herein by reference in its entirety.

### TECHNICAL FIELD

The present invention relates generally to headwear and, in particular, to a lighted, translucent hat.

### BACKGROUND ART

Although the basic cowboy hat has traditionally been a work hat, more recently they have also become fashion wear and are being worn at entertainment venues.

### SUMMARY OF THE INVENTION

The present invention provides a hat, comprising a brim, a crown, electroluminescent (EL) wire forming an outline at least around the brim and the crown, a battery pack secured to the underside of the crown, and a controller, secured to the underside of the crown and electrically coupled to the battery pack and the EL wire, configured to control the current applied to the EL wire. The brim and crown are formed from a translucent material.

The present invention also provides a method of manufacturing a hat, comprising: providing a translucent material, forming a brim and crown of the translucent material, securing an electroluminescent (EL) wire around at least the brim and crown, providing a battery pack, providing a controller, electrically coupling the EL wire to the battery pack and controller, and securing the battery pack and controller to the underside of the crown. The controller is configured to control the current applied to the EL wire.

### BRIEF DESCRIPTION OF THE DRAWINGS

FIG. 1 is a perspective outline view of an embodiment of a lighted, translucent hat of the present invention;

FIG. 2 is a bottom outline view of the hat of FIG. 1;

FIG. 3 is a perspective view of the hat of FIG. 1;

FIG. 4 is a bottom view of the hat of FIG. 1;

FIG. 5 is an embodiment of an electrical block diagram of the hat of FIG. 1;

FIG. 6 is a is a perspective view of the hat of FIG. 1 in the lighted state; and

FIG. 7 is a is a top view of the hat of FIG. 1 in the lighted state.

### DETAILED DESCRIPTION OF THE PREFERRED EMBODIMENT

The described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

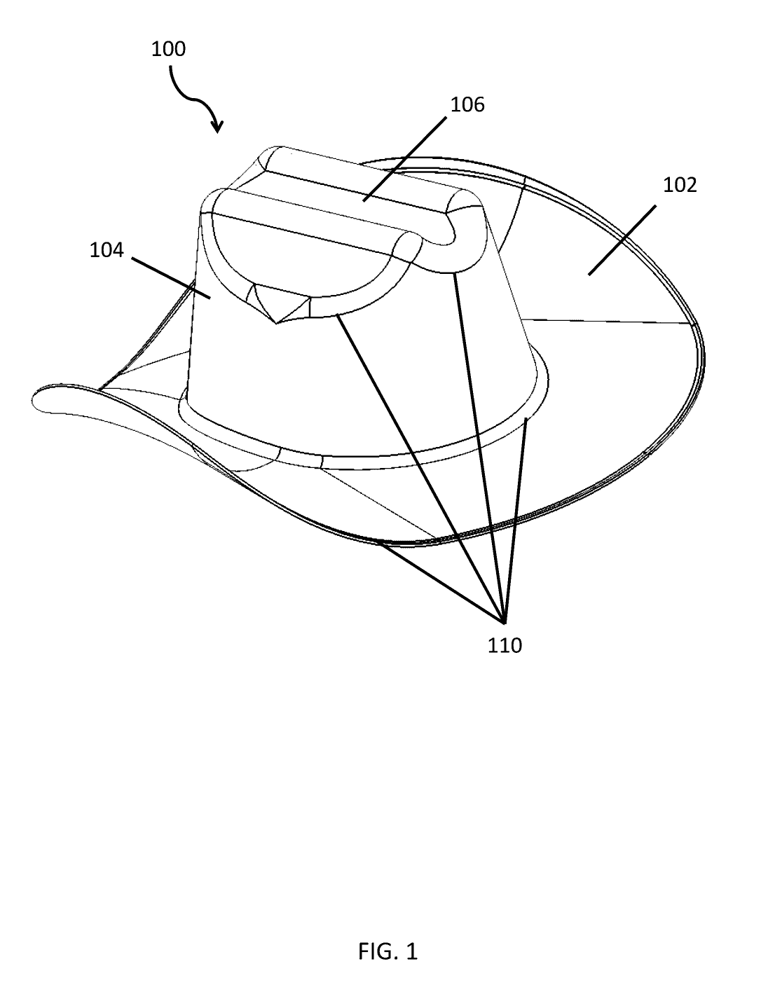

FIG. 1 is a perspective outline view of an embodiment of a lighted, translucent hat 100 of the present invention. The hat 100 illustrated in the FIGs. is a cowboy hat but the present invention is not limited to any one particular style of hat. The hat 100 includes a brim 102, a crown 104, and several creases 106 providing the overall shape of the hat 100. The hat 100 may be formed from a molded or plastic injected translucent material. As used herein, the term “translucent” refers to material through which at least some light may be transmitted and includes “transparent” material. If desired, ventilation holes may be formed in the crown 104 of the hat 100.

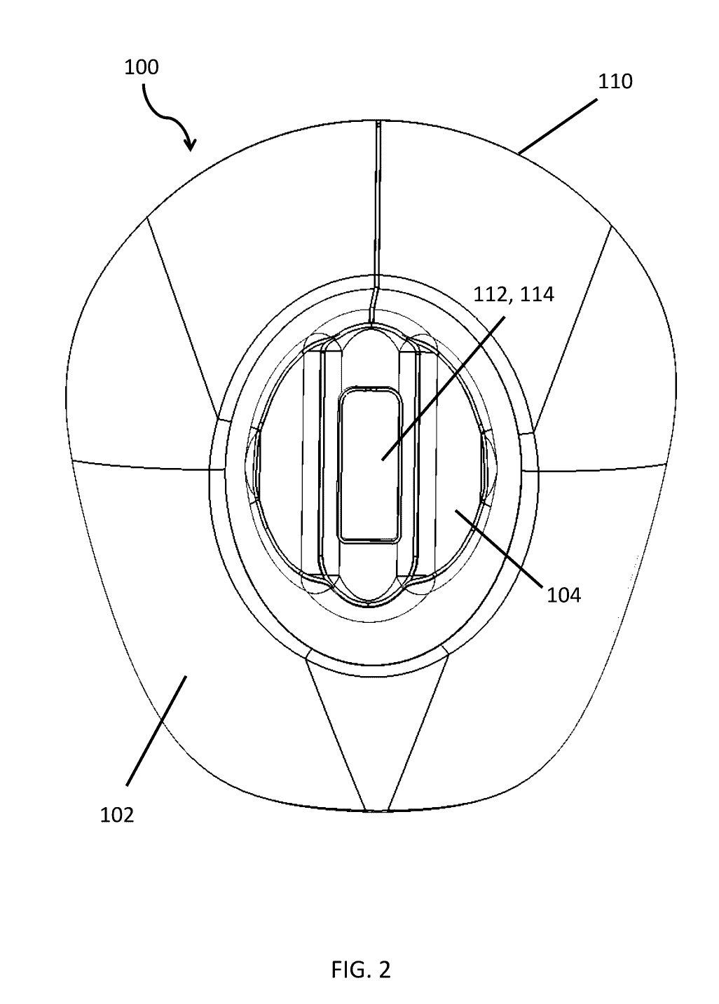

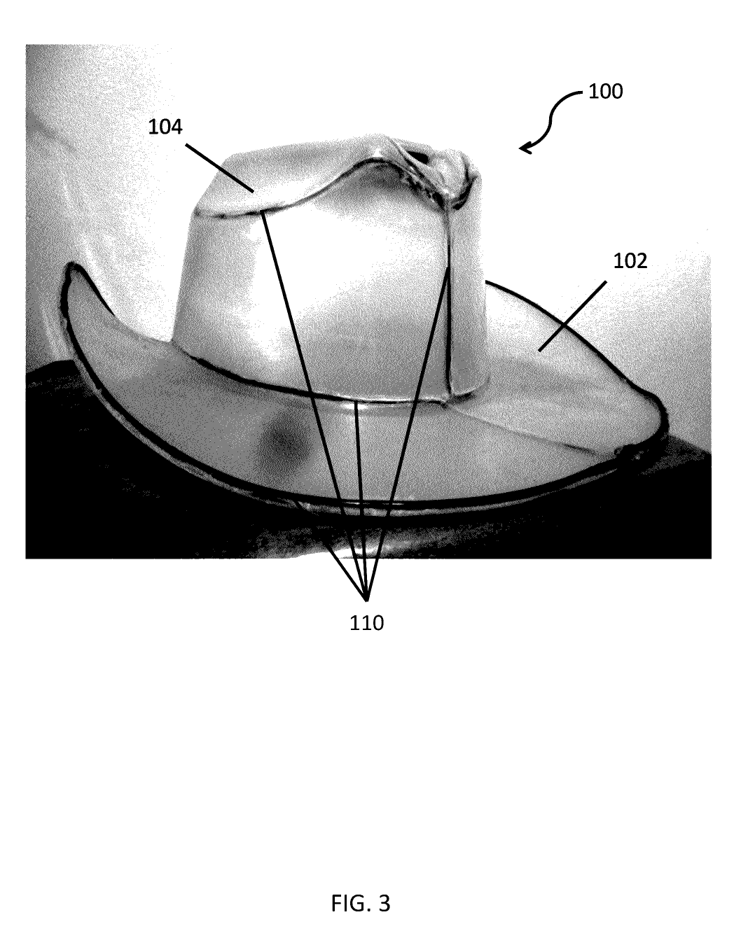

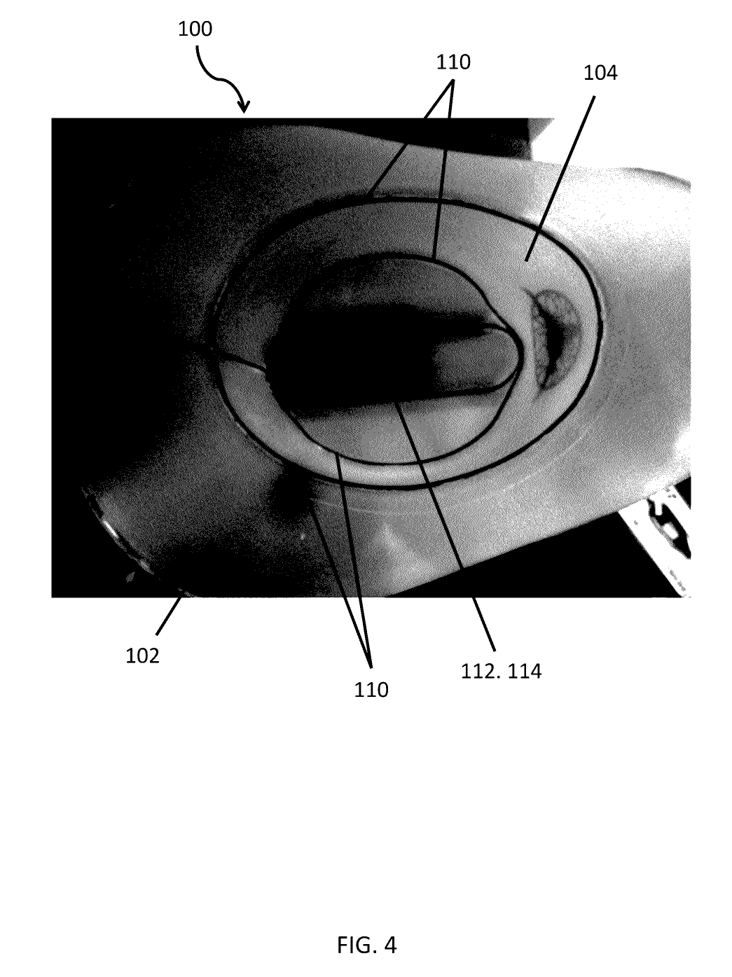

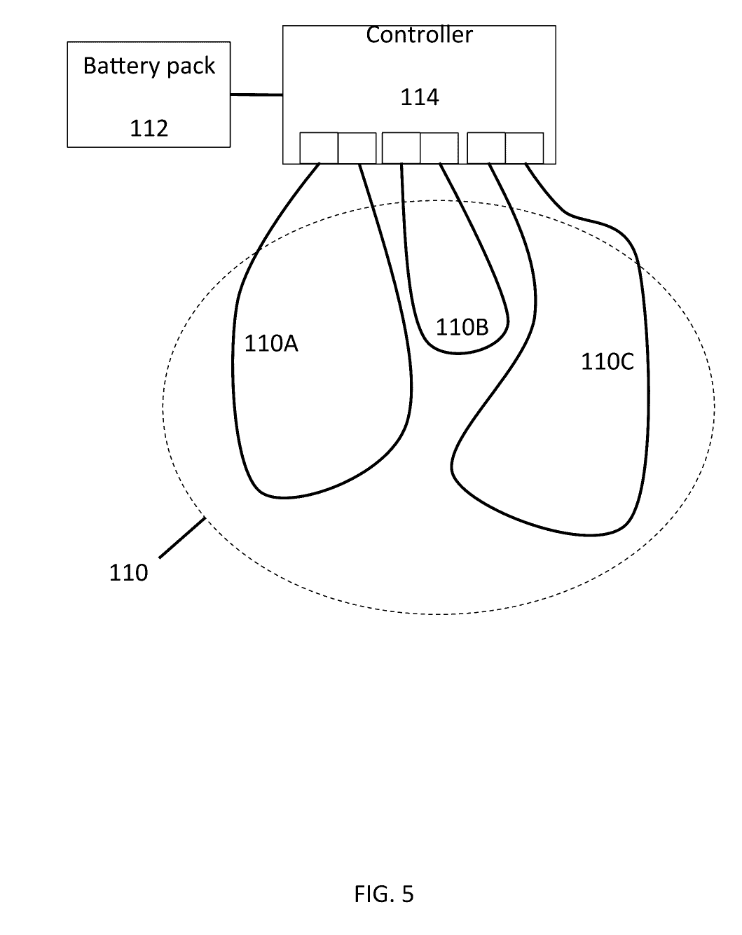

The hat 100 further includes flexible electroluminescent (EL) wire 110 secured to the material or molded or embedded into the hat 100, such as around perimeter of the brim 102 and crown 104, as illustrated in FIGS. 3 and 4. A battery pack 112 and controller 114, are electrically coupled to the EL wire 110, as illustrated in the block diagram of FIG. 5. The battery pack 112 and controller 114, which may be contained in a single housing or may be separate units, may be secured in the underside of the crown (FIGS. 2 and 4). As is known, when a current from the battery pack 112 through the controller 114 is applied to the EL wire 110, the wire 110 emits light.

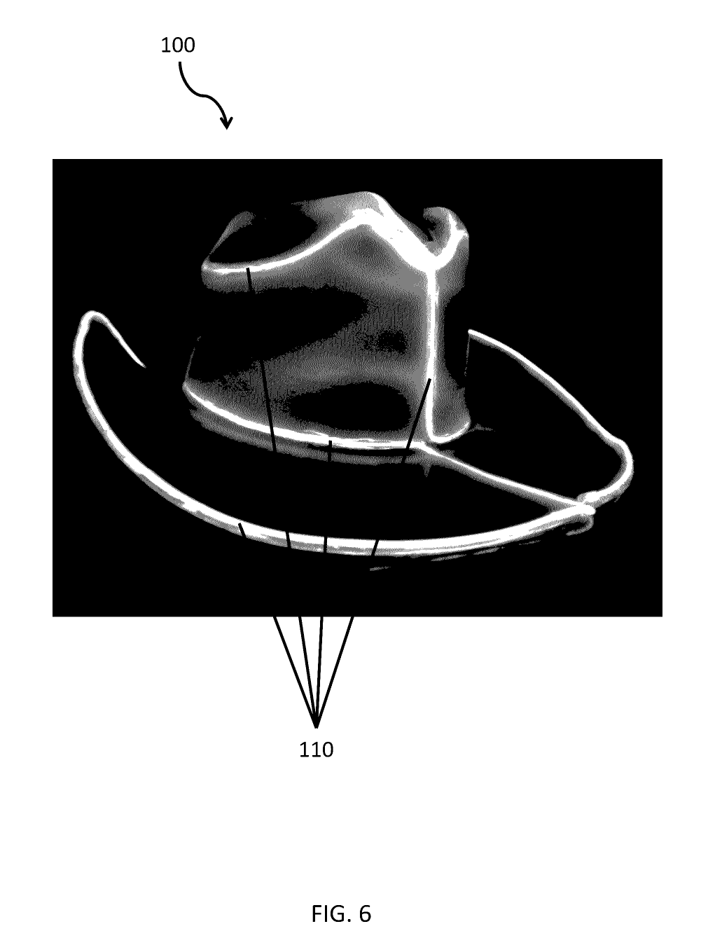

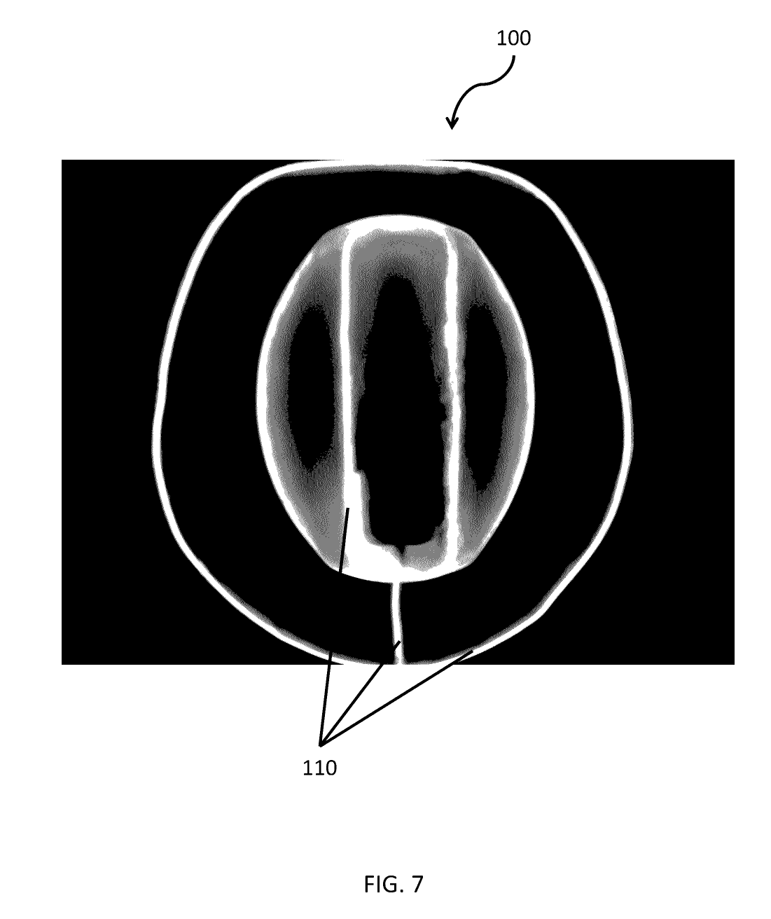

FIGS. 6 and 7 illustrate the hat 100 with the EL wire 110 in the lighted state.

The translucent material of the hat 100 allows the light to be disbursed throughout the hat 100, causing much or all of the hat 100 to glow. Because the EL wire 110 is available in a variety of colors, the hat 100 will glow with whatever color EL wire is selected. Alternatively, or in addition, the translucent material of the hat 100 may be of any of a variety of colors, enhancing the glow of the hat 100 when the EL wires are in the lighted state and providing color to the hat 100 when the EL wires are in the unlighted state. Further, the controller 114 may provide a variety of programmed light sequences, selectable by the wearer of the hat, including, but not limited to, continuously on, flashing at one of several selectable fixed rates, and flashing at one of several selectable patterns. The controller 114 may also include a microphone and appropriate sound-activated circuitry to convert sounds, such as music, into control signals such that the EL wire 110 flashes in time to the sound.

Black light reactive material may also be embedded into the translucent material of the hat 100 to provide additional light effects in the dark. If desired, a logo or other writing or design may be applied to or embedded in the hat 100, such as at the front of the crown 104, to provide a glowing cattle brand effect when the EL wire is lit. The brand may be applied as paint or the like, or may be formed from EL wire 100. With an appropriate controller 114, EL wire 100 of different colors may be used and may be controlled separately. FIG. 5 illustrates a circuit having three different EL wires 110A, 110B, 110C, each coupled to different connectors of the controller 114, allowing for individual control of each of the EL wires 110A, 110B, 110C, selectable by the wearer of the hat.

As previously noted, it will be appreciated that, although the hat described and illustrated herein is a cowboy hat, the present invention is not limited to this embodiment but may also include any other style of hat, including, but not limited to, baseball hats.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hat, comprising:
a brim;
a crown;
the brim and crown formed from a translucent material;
electroluminescent (EL) wire forming an outline at least around the brim and the crown;
a battery pack secured to the underside of the crown; and
a controller, secured to the underside of the crown and electrically coupled to the battery pack and the EL wire, configured to control the current applied to the EL wire.

2. The hat of claim 1, wherein the EL wire is secured to the translucent material.

3. The hat of claim 1, wherein the EL wire is embedded into the translucent material.

5. The hat of claim 1, wherein the controller is configured to provide a plurality of user-selectable lighting programs.

6. The hat of claim 1, wherein the EL wire comprises a plurality of EL wires separately coupled to and controlled by the controller.

7. The hat of claim 6, wherein each of the plurality of EL wires comprises a different color.

8. The hat of claim 6, wherein the controller is configured to provide a plurality of user-selectable lighting programs for the plurality of EL wires.

9. The hat of claim 1, wherein the translucent material is formed in the shape of a cowboy hat.

10. The hat of claim 1, wherein the translucent material is a colored material.

11. A method of manufacturing a hat, comprising:
providing a translucent material;
forming a brim and crown of the translucent material;
securing an electroluminescent (EL) wire around at least the brim and crown;
providing a battery pack;
providing a controller;
electrically coupling the EL wire to the battery pack and controller, the controller configured to control the current applied to the EL wire; and
securing the battery pack and controller to the underside of the crown.

12. The method of claim 11, wherein securing the EL wire around at least the brim and crown comprises securing the EL wire to the outside of the brim and crown.

13. The method of claim 11, wherein securing the EL wire around at least the brim and crown comprises embedding the EL wire within the translucent material.

14. The method of claim 11, wherein securing the EL wire around at least the brim and crown comprises securing a plurality of EL wires around at least the brim and crown.

15. The method of claim 14, wherein each of the plurality of EL wires comprises a different color.

16. The method of claim 14, wherein providing the controller comprises providing a controller configured to be coupled to the plurality of EL wires and to separately control each EL wire with a user-selectable lighting program.

17. The method of claim 14, wherein providing the controller comprises providing a controller configured to provide a plurality of user-selectable lighting programs.

18. The method of claim 14, wherein providing the translucent material comprises providing a colored translucent material.
